(19) United States
(12) Patent Application Publication
(10) Pub. No.: US 2023/0308848 A1
(43) Pub. Date: Sep. 28, 2023

(54) Systems and Methods for Sending Notifications to Vehicle Operators Upon Detecting a Likely Occurrence of a Vehicular Accident or Collision

(71) Applicant: David M. Van Sant, Cumming, GA (US)

(72) Inventor: David M. Van Sant, Cumming, GA (US)

(21) Appl. No.: 17/701,946

(22) Filed: Mar. 23, 2022

(51) Int. Cl. H04W 4/90; H04W 4/38

(52) U.S. Cl. CPC H04W 4/90; H04W 4/38

(57) ABSTRACT

A personal computing device (PCD) comprises at least a first sensor configured to sense conditions surrounding the PCD and to generate output signals indicative of the sensed conditions and an event detection system comprising a processor configured to perform an event detection algorithm that monitors and processes the output signals generated by said at least one sensor to determine if a high likelihood exists that a vehicle in which the PCD is traveling has been involved in an accident or collision. If so, the processor cause at least one notification to be output on at least one output device of the PCD. The notification conveys information to a user of the PCD about at least one assistance provider, which can be, for example, a person, a hospital, an emergency responder, a medical professional, a fire department, a personal injury attorney, and an insurance agent.

### TECHNICAL FIELD

The present disclosure relates to personal computing devices (PCDs), and more particularly, to using one or more sensors of a PCD, such as a smartphone, for example, to detect when a vehicular accident or collision has occurred and for sending a notification to the vehicle operator via the vehicle operator's PCD.

### BACKGROUND

Smartphones that are available today are equipped with a variety of sensors and software Applications (Apps) that provide the user with a variety of functions. These functions range from functions associated with useful day-to-day operations to leisure and entertainment. Some of the Apps are installed by the user after purchasing the smartphone, whereas others are installed in the factory. Sensors currently available on smartphones include, for example, Global Positioning System (GPS) sensors, accelerometer sensors, magnetometer sensors, gyroscope sensors, biometric sensors, various types of touch sensors and various types of optical sensors.

For all of these different types of sensors, a chip set of the smartphone has one or more processors that execute an App or other software and/or firmware that process the sensor outputs to cause the smartphone to perform certain operations and/or to provide the user with audio, visual and/or mechanical output or feedback. As the processing capability and storage capacity of the smartphone chipsets have increased, so have the number and complexity of the computer programs that can run on these chipsets.

The outputs of GPS, gyroscope and accelerometer sensors can be used in combination to determine the location, direction of motion, velocity, acceleration and orientation of the smartphone. When the smart phone is traveling in a vehicle, this same information can be used to determine the location, direction of motion, velocity, acceleration and orientation of the vehicle.

### SUMMARY

The present disclosure discloses a system, method and computer program implemented by a personal computing device (PCD), such as a smart phone, for example, that monitors and processes output signals generated by one or more sensors of the PCD to determine if a high likelihood exists that a vehicle in which the PCD is traveling has been involved in an accident or a collision, and if so, to cause a notification to be output on one or more out devices of the PCD to convey information about an assistance provider to a user of the PCD.

In accordance with an exemplary embodiment, the system comprises a PCD comprising at least a first sensor configured to sense conditions surrounding the PCD and to generate output signals indicative of the sensed conditions and an event detection system comprising a processor configured to perform an event detection algorithm that monitors and processes the output signals generated by the sensor(s) to detect if a high likelihood exists that a vehicle in which the PCD is traveling has been involved in an accident or collision, and if so, to cause at least one notification to be output on at least one output device of the PCD. The notification conveys information to a user of the PCD about at least one assistance provider.

In accordance with an exemplary embodiment of the method, the method comprises:
with at least a first sensor of a PCD, sensing conditions surrounding the PCD and generating output signals; and
with a processor of an event detection system of the PCD, performing an event detection algorithm that monitors and processes the output signals generated by said at least a first sensor to detect if a high likelihood exists that a vehicle in which the PCD is traveling has been involved in an accident or collision, and if so, causing at least one notification to be output on at least one output device of the PCD, where the notification(s) conveys information to a user of the PCD about at least one assistance provider.

In accordance with an exemplary embodiment of the computer program, the computer program is embodied on a nontransitory computer-readable medium and comprises at least first and second code segments. The first code segment receives output signals generated by at least a first sensor of a PCD, where the output signals correspond to conditions surrounding the PCD that are sensed by the sensor(s). The second code comprises an event detection algorithm that monitors and processes the output signals generated by at least the first sensor to determine if a high likelihood exists that a vehicle in which the PCD is traveling has been involved in an accident or collision, and if so, causes at least one notification to be output on at least one output device of the PCD, where the notification conveys information to a user of the PCD about at least one assistance provider.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever Applicable and practical, like reference numerals refer to like elements.

FIG. 1 is a functional block diagram illustrating an exemplary embodiment of a system for detecting whether a high likelihood exists that a vehicle has been involved in an accident or collision, and if so, for outputting a notification to the user to inform the user of how to obtain one or more types of assistance.

FIG. 2 is a flow diagram of the method in accordance with an exemplary embodiment for detecting if a vehicle in which the PCD is traveling has been involved in an accident or collision, and if so, for outputting one or more notifications to the user of the PCD on one or more notification output devices of the PCD.

FIG. 3 is a flow diagram of the method in accordance with an exemplary embodiment for detecting if a vehicle in which the PCD is traveling has been involved in an accident or collision, and if so, for sending one or more notifications from the PCD to one or more assistance providers.

FIG. 4 is a functional block diagram illustrating an exemplary, non-limiting aspect of the PCD shown in FIG. 1 comprising a mobile phone or smart phone, for implementing the methods disclosed in the present disclosure.

FIG. 5 is a flow diagram of the method in accordance with an exemplary embodiment in which the event detection algorithm is the same as the event detection algorithm shown in FIG. 2 except that the algorithm shown in FIG. 5 performs additional steps or processes not depicted in FIG. 2.

FIG. 6 is a flow diagram of the method in accordance with an exemplary embodiment in which the event detection algorithm is the same as the event detection algorithm shown in FIG. 5 except that the algorithm shown in FIG. 6 performs additional steps or processes not depicted in FIG. 5.

FIG. 7 is a flow diagram of the method in accordance with an exemplary embodiment in which the event detection algorithm is the same as the event detection algorithm shown in FIG. 6 except that the portion of the process after block 603 in FIG. 6 is performed by a processor of the network shown in FIG. 1.

### DETAILED DESCRIPTION

The present disclosure is directed to various representative embodiments of a system and method that detect the likelihood that a vehicle has been in an accident or collision based on the output of one or more sensors of a smartphone and cause certain information to be provided to the user via one or more output devices of the smartphone. In accordance with a representative embodiment, the system comprises a processor of the smartphone that executes an App that is installed on the smartphone. When the processor is executing the App, the output signal of one or more sensors of the smartphone or other portable computing device (PCD) is monitored to detect the occurrence of a change in motion and/or orientation that indicates a high likelihood that the vehicle has been involved in an accident or collision. If such an occurrence is detected, the processor causes certain information to automatically be outputted to the user via one or more output devices of the smartphone.

The information that is automatically outputted to the user via one or more output devices of the smartphone can comprise, for example, information associated with one or more assistance providers. The information can include, for example, a name, a phone number, an email address and/or a website of an assistance provider. An assistance provider can be, for example, a person, a hospital, an emergency responder, a fire department, a medical professional, a personal injury attorney, an insurance agent, etc. Providing such information to the smartphone user at nearly the instant in time when the accident or collision occurred allows the user to make decisions at the earliest possible moment in time when the user is likely to be in need of assistance.

Aspects, features and advantages of several exemplary embodiments of systems and methods of the present disclosure will become better understood with regard to the following description in connection with the accompanying drawings. It will be Apparent to one of ordinary skill in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, any use of absolute terms such as, for example, “will,” “will not,” “shall,” “shall not,” “must” and “must not” are not meant to limit the scope of the disclosure as the particular embodiments disclosed herein are merely exemplary.

The word “exemplary” is used herein to mean serving as an example, instance, or illustration. Any aspect described herein as “exemplary” is not necessarily to be construed as exclusive, preferred or advantageous over other aspects.

In this description, the term “Application” or “App” may also include files having executable content, such as: object code, scripts, byte code, markup language files, and patches. In addition, an “App” referred to herein, may also include files that are not executable in nature, such as documents that may need to be opened or other data files that need to be accessed.

In this description, the terms “subject,” “operator” and “user” are used interchangeably unless otherwise noted.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an App running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” “processing component” and “chip” are used interchangeably. Moreover, a CPU, DSP, GPU or chip may be comprised of one or more distinct processing components generally referred to as “core(s).”

In this description, the term “portable computing device” (“PCD”) is used to describe any device operating on a limited capacity power supply, such as a battery. Therefore, a PCD may be, for example, a cellular telephone, a satellite telephone, a pager, a PDA, a smartphone, a navigation device, a smartbook or reader, a media player, a combination of the aforementioned devices, a laptop computer with a wireless connection, a remote sensor package worn by a user, among others.

In this description, exemplary embodiments of a system are described to comprise an event detection system disposed on a PCD. The event detection system can comprise, for example, one or more of a GPS sensor, an accelerometer sensor, a magnetometer sensor, a gyroscope sensor, and a motion sensor. The output(s) of one or more of these sensors is monitored by the event detection system to detect a high likelihood that a vehicle in which the PCD is traveling has been involved in an accident or collision. Specific reference herein to a particular one of these sensors or a particular group of these sensors being used is not meant to limit the scope of the disclosure or otherwise suggest that an embodiment must include that sensor. For instance, it is envisioned that embodiments where the event detection system includes an accelerometer may, alternatively or additionally, include other motion sensing devices such as a gyroscope sensor and/or a GPS sensor or the like. Other sensors and combinations of sensors for sensing such events are envisioned. As such, one of ordinary skill in the art will recognize that reference to an accelerometer, for example, in this description is for illustrative purposes only and is not meant to suggest that all embodiments must include specifically an accelerometer.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and Appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or more memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

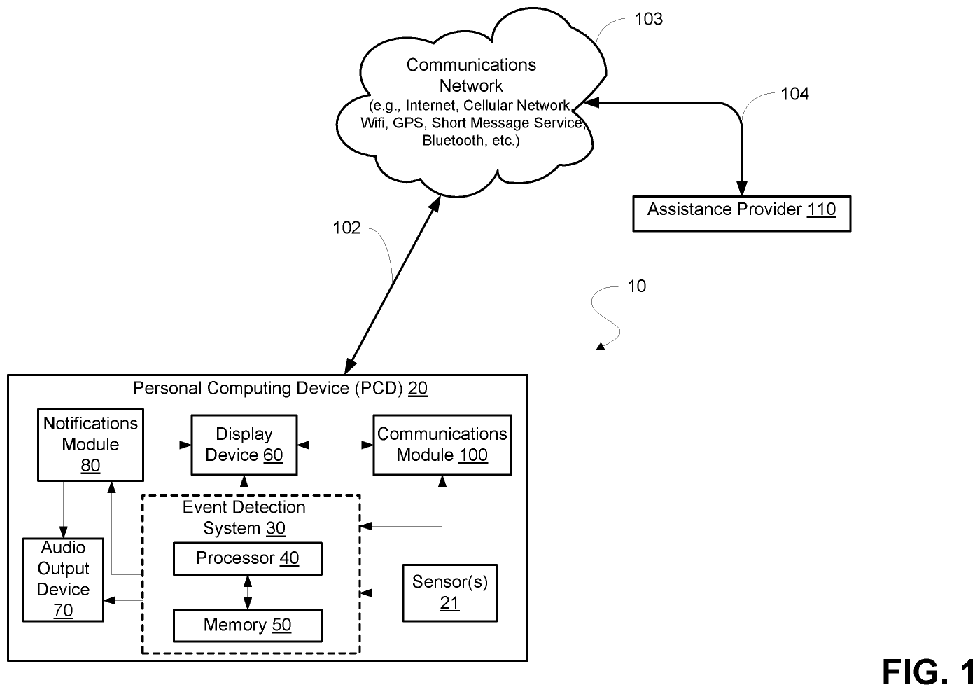

FIG. 1 is a functional block diagram illustrating an exemplary embodiment of a system 10 for detecting whether a high likelihood exists that a vehicle has been involved in an accident or collision, and if so, for outputting a notification to the user to inform the user of how to obtain one or more types of assistance. In accordance with this exemplary embodiment, the system 10 comprises a PCD 20, such as, for example, a smartphone. One or more sensors 21 of the PCD 20 sense conditions surrounding the PCD 20 and generate output signals that are received by an event detection system 30 of the PCD 20. A processor 40 of the event detection system 30 is configured to perform an event detection algorithm that monitors and processes the output signals generated by the sensor(s) 21 to determine whether or not an event has occurred that indicates a high likelihood that a vehicle in which the PCD 20 is traveling has been involved in an accident or collision.

The event detection algorithm can be implemented in hardware, software, firmware, or a combination thereof. For exemplary purposes, it is assumed that the algorithm is an App that resides on the PCD 20 and is implemented in software. The computer code comprising the App can be stored in a memory device 50 of the PCD 20. The memory device 50 can be any suitable non-transitory computer-readable medium that is accessible by the processor 40.

If the processor 40 performing the event detection App determines that the output signals generated by the sensor(s) 21 indicate that an event has occurred that indicates a high likelihood that an accident or collision has occurred, the processor 40 outputs a notification to the user of the PCD 20 via one or more notification output devices of the PCD 20, such as a display device 60 of the PCD 20 and/or an audio output device 70 (e.g., an audio speaker) of the PCD 20. The processor 40 can directly access the notification output devices 60 and 70 or it can communicate with a notifications module 80 that communicates with the notification output devices 60 and 70 to cause them to output the appropriate notifications. For example, the notifications module 80 can be configured to cause a visual notification or an audio notification to be displayed on the display device 60 or output on the audio output device 70, respectively.

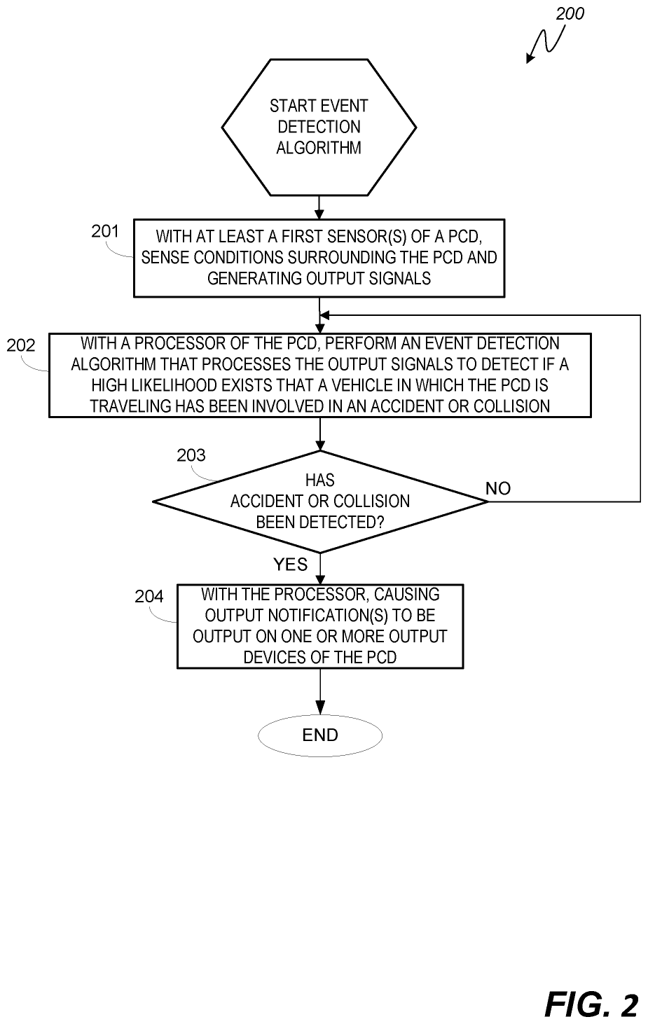

FIG. 2 is a flow diagram of the method 200 in accordance with an exemplary embodiment for detecting if a vehicle in which the PCD is traveling has been involved in an accident or collision, and if so, for outputting one or more notifications to the user of the PCD on one or more notification output devices of the PCD. With at least a first sensor of the PCD, conditions surrounding the PCD are sensed and output signals are generated, as indicated by block 201. With a processor of an event detection system of the PCD, an event detection algorithm is performed that monitors and processes the output signals generated by the sensor(s) to detect if a high likelihood exists that a vehicle in which the PCD is traveling has been involved in an accident or collision, as indicated by block 202. As indicated by block 203, if so, the processor causes at least one notification to be output on at least one notification output device of the PCD, as indicated by block 204; if not, the process returns to block 202 and the processes represented by blocks 202 and 203 are repeated.

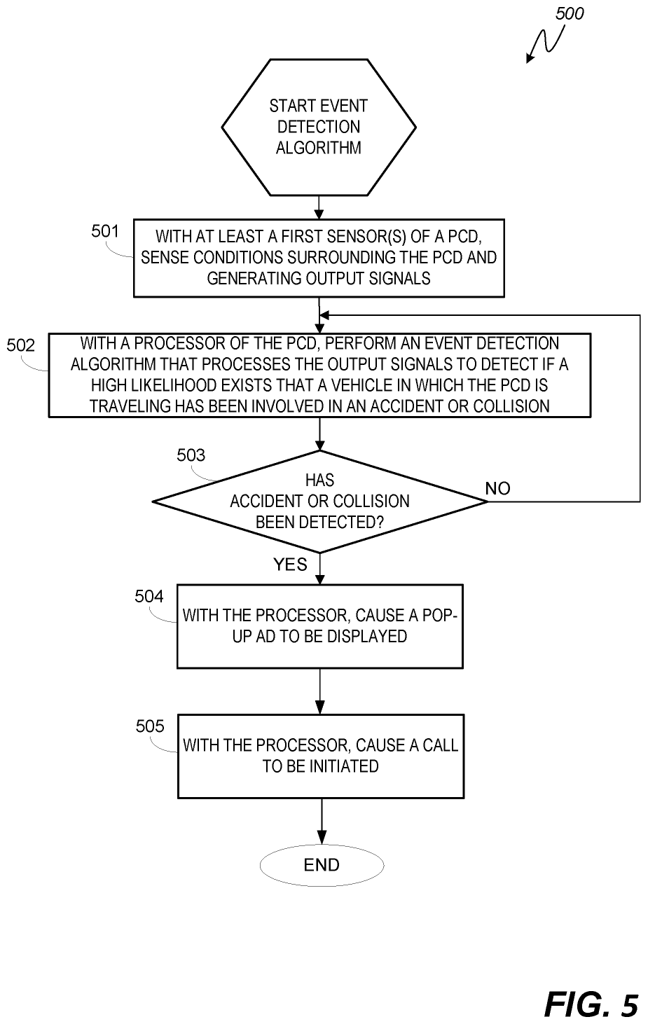

After block 204, the process will typically terminate, although additional steps or processes can be performed, as will be described below in more detail with reference to FIG. 5. For example, the process represented by block 204 can be performed repeatedly or periodically, such as once per hour until the user takes some action to dismiss the advertisement, such as by clicking on it or closing it in the way that an App is typically closed.

The event detection algorithm 200 can run continuously. Alternatively, the processor 40 can start the event detection algorithm when it detects that output signals generated by one or more of the sensor(s) of the PCD 20 indicate that the PCD 20 is traveling in a vehicle. For example, the processor 40 can monitor the output signals of at least one of a GPS sensor, an accelerometer sensor, a magnetometer sensor, and a gyroscope sensor to determine when the PCD is traveling at a rate of speed that is sufficiently high that the PCD must be traveling in a vehicle that is being driven, and then start the event detection algorithm. The event detection algorithm can monitor one or more of these same output signals to detect, for example, that the motion of the PCD has come to an abrupt stop, for example, indicating a high likelihood that the vehicle in which the PCD is traveling has been involved in a collision or accident. Other sensor output signals can also be analyzed to detect a high likelihood that an accident or collision has occurred, such as if the motion of the PCD as sensed by a GPS sensor of the PCD indicates that the PCD has abruptly left the route along which it was traveling and is no longer traveling along a viable route. Persons of skill in the art will understand, in view of the discussion provided herein, the manner in which a variety of sensor outputs can be analyzed to detect a high likelihood that a vehicle in which the PCD was traveling has been involved in an accident or collision.

In addition to the exemplary embodiment of the method described above with reference to FIGS. 1 and 2, in accordance with an exemplary embodiment, the processor 40, upon detecting that an event has occurred that indicates a high likelihood that an accident or collision has occurred, can output a notification to an assistance provider 101 who is associated with the notification that is output to the notification output devices 60 and/or 70. The notification sent by the processor 40 to the assistance provider 101 can be communicated via a wired or wireless communications link 102 to a communications network 103, and from the communications network 103 over a wired or wireless communications link 104 to the assistance provider 101. The processor 40 can interact with a communications module 100 of the PCD 20 to establish a communications session with the assistance provider 101 via the communications network 103 and links 102 and 104.

The notification that is sent to the assistance provider 101 can be in the form of, for example, a phone call, an SMS message, and/or an email message, and can include, for example, the location and time at which the accident or collision occurred as well as the name, phone number, residence address and/or email address of the user of the PCD 20.

The assistance provider 110 can be any person, group of people or institution, for example, that can provide assistance to someone who has been in an accident or collision such as, for example, a person, a hospital, an emergency responder, a fire department, a personal injury attorney, an insurance agent, a medical professional, etc. Providing such information to the assistance provider 110 allows the assistance provider 110 to contact the user of the PCD 20 by any suitable form of communications and/or arrive at the scene of the event close to the instant in time at which the incident occurred.

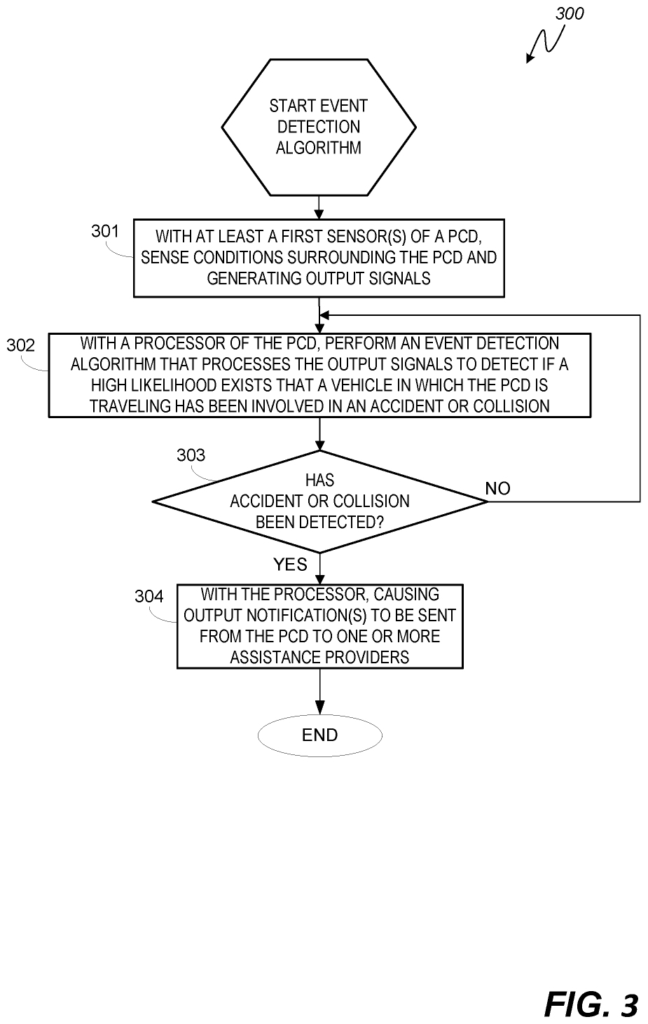

FIG. 3 is a flow diagram of the method 300 in accordance with an exemplary embodiment for detecting if a vehicle in which the PCD is traveling has been involved in an accident or collision, and if so, for sending one or more notifications from the PCD to one or more assistance providers. With at least a first sensor of the PCD, conditions surrounding the PCD are sensed and output signals are generated, as indicated by block 301. With a processor of an event detection system of the PCD, an event detection algorithm is performed that monitors and processes the output signals generated by the sensor(s) to detect if a high likelihood exists that a vehicle in which the PCD is traveling has been involved in an accident or collision, as indicated by block 302. As indicated by block 303, if so, the processor causes at least one notification to be sent from the PCD to at least one assistance provider, as indicated by block 304; if not, the process returns to block 302 and the process represented by blocks 302 and 303 is repeated. After block 304, the process will typically terminate, although additional steps or processes can be performed, as will be described below in more detail with reference to FIG. 5.

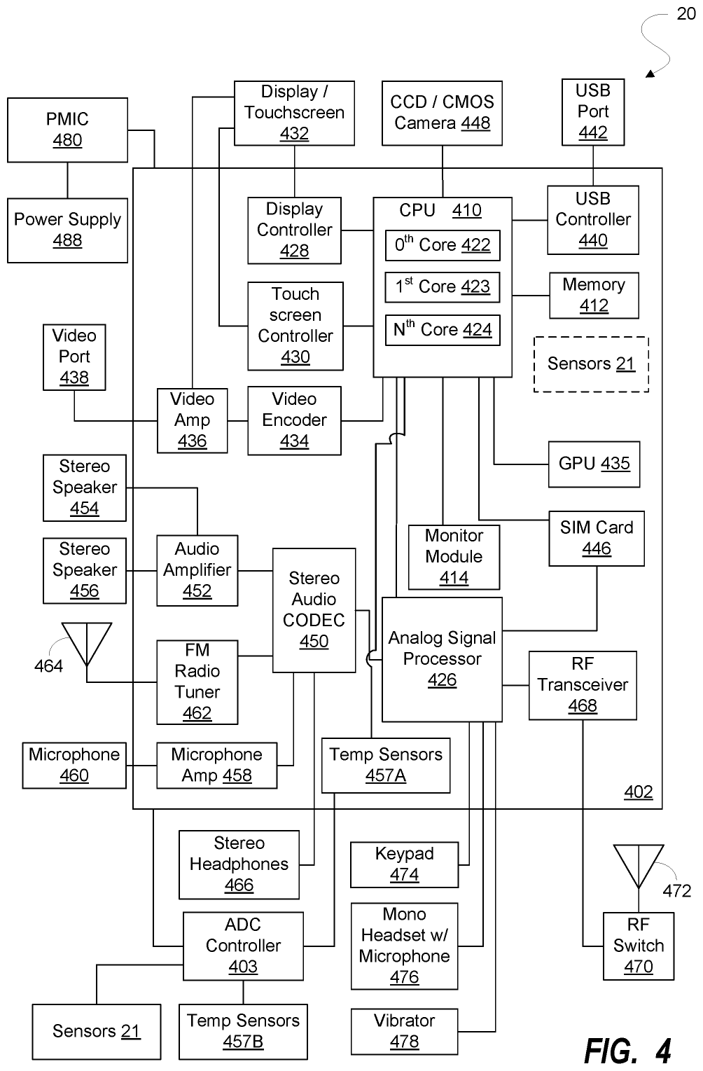

FIG. 4 is a functional block diagram illustrating an exemplary, non-limiting aspect of the PCD 20 shown in FIG. 1 comprising a mobile phone or smart phone, for implementing the methods disclosed in the present disclosure. As shown, the PCD 20 can comprise a system-on-a-chip (SOC) 402 that includes a multi-core central processing unit (“CPU”) 410 and an analog signal processor 426 that are coupled together. The CPU 410 may comprise a zeroth core 422, a 1^{st} core 423, and an N^{th} core 424, as understood by one of ordinary skill in the art, where N is a positive integer that is greater than or equal to one. Further, instead of a CPU 410, a digital signal processor (“DSP”) or some other processor may be employed as will be understood by one of ordinary skill in the art.

In general, the event detection system 30 shown in FIG. 1 may be formed from hardware and/or firmware and/or software of the PCD 20 and may be responsible for determining when certain sensor(s) output signal(s) should be taken and performing the event detection algorithm that calculates the likelihood that a vehicular accident or collision has occurred.

As illustrated in FIG. 4, a display controller 428 and a touch screen controller 430 are coupled to the CPU 410. A touch screen display 432 external to the SOC 402 can be coupled to the display controller 428 and to the touch screen controller 430. PCD 20 may further include a video encoder 434, e.g., a phase-alternating line (“PAL”) encoder, a sequential couleur avec memoire (“SECAM”) encoder, a national television system(s) committee (“NTSC”) encoder or any other type of video encoder 434. The video encoder 434 is coupled to the multi-core CPU 410. A video amplifier 436 is coupled to the video encoder 434 and to the touch screen display 432. A video port 438 is coupled to the video amplifier 436. A universal serial bus (“USB”) controller 440 is coupled to the CPU 410. Also, a USB port 442 is coupled to the USB controller 440. A memory 412, which may include, for example, a PoP memory, a cache, a mask ROM/Boot ROM, a boot OTP memory, a DDR memory may also be coupled to the CPU 410.

A subscriber identity module (“SIM”) card 446 may also be coupled to the CPU 410 and to an analog signal processor 426. A digital camera 448 may be coupled to the CPU 410. In an exemplary aspect, the digital camera 448 is a charge-coupled device (“CCD”) camera or a complementary metal-oxide semiconductor (“CMOS”) camera.

As further illustrated in FIG. 4, a stereo audio CODEC 450 may be coupled to the analog signal processor 426. Moreover, an audio amplifier 452 may be coupled to the stereo audio CODEC 450. In an exemplary aspect, a first stereo speaker 454 and a second stereo speaker 456 are coupled to the audio amplifier 452. A microphone amplifier 458 may be also coupled to the stereo audio CODEC 450. Additionally, a microphone 460 may be coupled to the microphone amplifier 458, which may also be coupled to the stereo audio CODEC 450. In a particular aspect, a frequency modulation (“FM”) radio tuner 462 may be coupled to the stereo audio CODEC 450. Also, an FM antenna 464 is coupled to the FM radio tuner 462. Further, stereo headphones 466 may be coupled to the stereo audio CODEC 450.

FIG. 4 further indicates that a radio frequency (“RF”) transceiver 468 may be coupled to the analog signal processor 426. An RF switch 470 may be coupled to the RF transceiver 468 and to an RF antenna 472. A keypad 474 may be coupled to the analog signal processor 426. Also, a mono headset with a microphone 476 may be coupled to the analog signal processor 426. Further, a vibrator device 478 may be coupled to the analog signal processor 426. FIG. 4 also shows that a power supply 488, for example a battery, is coupled to the SOC 402 through a power management integrated circuit (“PMIC”) 480. In a particular aspect, the power supply 488 includes a rechargeable DC battery or a DC power supply that is derived from an alternating current (“AC”) to DC transformer that is connected to an AC power source. In another particular aspect, the power supply 488 includes a kinetically rechargeable DC battery.

The CPU 410 may also be coupled to one or more internal, on-chip thermal sensors 457A as well as one or more external, off-chip thermal sensors 457B and sensors 21 that may be used by the event detection system 30. The on-chip thermal sensors 457A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 457B may comprise one or more thermistors. The thermal sensors 457 may produce a voltage drop that is converted to digital signals with an analog-to-digital converter (“ADC”) controller 403. However, other types of thermal sensors 457 may be employed.

The sensors 21 shown in FIGS. 1 and 4 that can be used by the event detection algorithm may include, but are not limited to including, GPS sensors, accelerometer sensors, magnetometer sensors, gyroscope sensors, and any other types of sensors that can be used to sense changes in position, motion, speed, velocity, acceleration and/or orientation of the PCD 20. It should be noted that although the sensors 21 are shown in FIG. 4 as being external to the SOC 402, some or all of the sensors 21 can be integrated into the SOC 402, as indicated by the dashed box labeled 21 in FIG. 4 that is inside the box labeled 402 in FIG. 4. The inventive principles and concepts of the present disclosure are not limited with regard to where the sensors 21 are located in the PCD 20.

The output signals that are outputted by the sensors 21 are converted into digital signals by the ADC controller 403 or by some other ADC of the PCD 20. The digital signals are outputted to the SOC 402. Suitable logic of the SOC 402 comprises the event detection system 30 shown in FIG. 1 that performs the event detection algorithm described above with reference to FIGS. 1, 2 and 3. For example, the CPU 410 can execute instructions comprising the event detection algorithm that are stored in the memory 412, which is a non-transitory computer-readable medium. Preferably, firmware and/or software stored in the memory 412 can be reconfigured, modified or updated periodically to allow the manner in which the event detection algorithm operates to be modified.

For the event detection algorithm described above with reference to FIG. 2, the CPU 410 or some other processor of the PCD 20 executing the event detection algorithm causes one or more output notifications to be outputted or presented visually on display/touchscreen 432, auditorily on speakers 454, 456, or stereo headphones 466 and/or audio-visually via video port 438 when it determines, based on the output signals generated by the sensors 21, that a high likelihood exists that a vehicle in which the PCD 20 is traveling has been involved in an accident or collision. For the event detection algorithm described above with reference to FIG. 3, the CPU 410 or some other processor of the PCD 20 executes instructions comprising the event detection algorithm to cause one or more notifications to be sent to one or more assistance providers via antenna 464 and/or 472 when the CPU 410 or other processor determines that a high likelihood exists that a vehicle in which the PCD 20 is traveling has been involved in an accident or collision. The memory 412 can also store data, such as, for example, bits representing the digital signals associated with the outputs of the sensors 21.

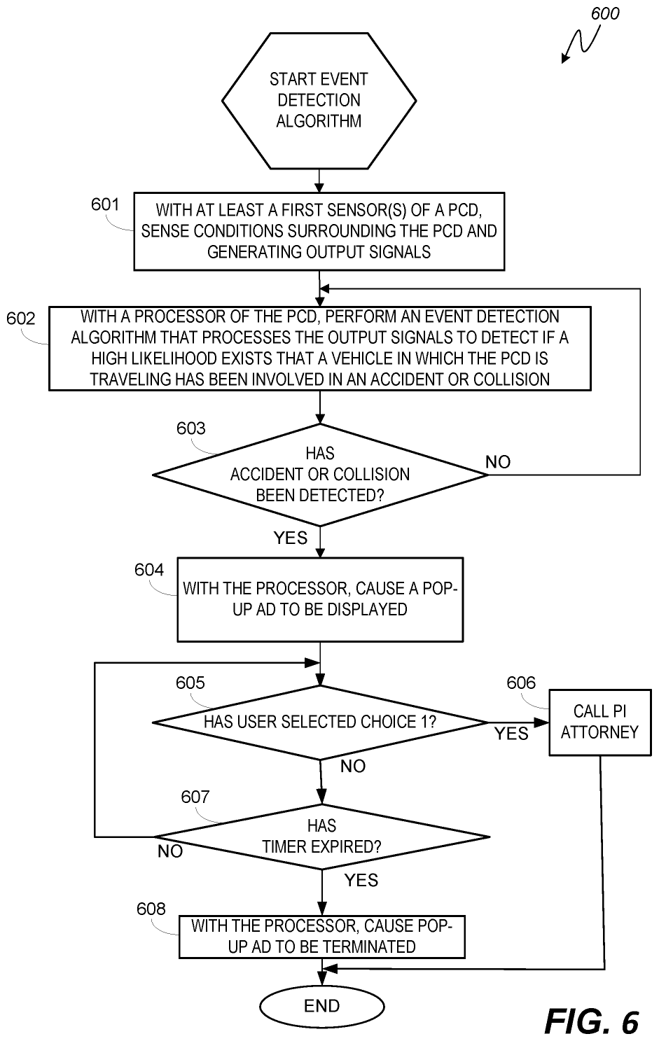

The touch screen display 432, the video port 438, the USB port 442, the camera 448, the first stereo speaker 454, the second stereo speaker 456, the microphone 460, the FM antenna 464, the stereo headphones 466, the RF switch 470, the RF antenna 472, the keypad 474, the mono headset 476, the vibrator 478, thermal sensors 457B, the sensors 21, the PMIC 480 and the power supply 488 are typically external to the SOC 402. It will be understood, however, that one or more of these devices depicted as external to the SOC 402 in the exemplary embodiment of a PCD 20 in FIG. 6 may reside on the SOC 402 in other exemplary embodiments.

A variety of modifications can be made to the exemplary embodiments discussed above. For example, the event detection algorithm can be an App that the user voluntarily downloads or it could be a native App that is pre-installed on the PCD 20, i.e., installed on the PCD 20 prior to the PCD 20 being shipped to, sold to or otherwise distributed to the user.

The notification can take on virtually any form, such as, for example, a pop-up advertisement that pops up on the phone's display, an audio announcement, an audio-visual presentation, a text message, an email message, etc., or a combination of two or more such notifications. The notification can either be passive in that it does not require any action on the part of the user or active in that it can require or request that some action be taken by the user. An example of a passive notification is a pop-up visual advertisement that the event detection algorithm causes to be displayed to provide information about a PI lawyer and/or his or her firm. In addition, the event detection algorithm can also cause the PCD to automatically initiate a call to the PI lawyer. An example of an active notification is an audio notification that the event detection algorithm causes to be played that asks the user to “say Yes or press one” to initiate a call to the PI attorney or “say No or press 2” to end the advertisement. In addition, the event detection algorithm may also cause the PCD 20 to automatically initiate a call, such as, for example, to 911, and then deliver the GPS coordinates of the user to the 911 responder.

FIG. 5 is a flow diagram of the method in accordance with an exemplary embodiment in which the event detection algorithm 500 is the same as the event detection algorithm 200 shown in FIG. 2 except that the algorithm 500 shown in FIG. 5 performs additional steps or processes not depicted in FIG. 2. Blocks 501-504 can be identical to blocks 201-204, respectively, shown in FIG. 2. The event detection algorithm 600 is active in that it requires that some action be taken by the user of the PCD 20. discussed above with reference to FIG. 2 ends once the notification(s) is output via one or more output devices of the PCD. In contrast, in accordance with the representative embodiment shown in FIG. 5, once the notification is output at block 504, the event detection algorithm causes a call to be initiated to the PI attorney, as indicated by block 505.

A variety of modifications can be made to the process depicted in FIG. 5. FIG. 6 is a flow diagram of the method in accordance with an exemplary embodiment in which the event detection algorithm 600 is the same as the event detection algorithm 500 shown in FIG. 5 except that the algorithm 600 performs additional steps or processes not depicted in FIG. 5. Blocks 601-604 can be identical to blocks 501-504, respectively, shown in FIG. 5. The process shown in FIG. 6 is active in that it requires that some action be taken by the user. At the step represented by block 605, the algorithm 600 determines whether the user has made a selection indicating the desire to initiate a call to the PI attorney. If so, the PCD 20 causes a call to be initiated to the PI attorney, as indicated by block 606. If not, the algorithm 600 determines whether a particular time period has passed, as indicated by block 607. If so, the pop-up ad is terminated, as indicated by bloc 608. If not, the process returns to block 605 and repeats. Once the time period has passed, the ad is terminated and the process ends.

A variety of modifications can be made to the algorithm 600. For example, instead of initiating a call at block 606, an email or text message may be sent to the PI attorney. Also, blocks 607 and 608 can be eliminated and the process represented by block 605 can repeat until choice 1 is selected. As another modification, after the process ends at either block 608, the timer in block 607 can be reset and the process can return to block 605. The choice made by the user at block 605 can be a key stroke, an audible reply, or any other kind of suitable selection.

Some of all of the event detection algorithm can be performed by a processor that is external to the PCD 20. For example, some portion of the process can be performed by a processor of the communications network 103 shown in FIG. 1. If the App comprising the event detection algorithm is a native App, i.e., an App that is pre-installed on the PCD 20, then the cell phone service providers may be involved in the event detection algorithm. For example, working through the cell phone service provider, multiple PI attorneys could be contacted and allowed the opportunity to “bid” to the cell service provider for their advertisements to be the advertisement that is displayed on the user's PCD 20 during certain time blocks and in certain geographic ranges. And, the prime geographic regions and time blocks (e.g., Atlanta connector from 6:30 A.M. to 9:30 A.M. Monday through Friday) would command the highest bids. This bid system approach could also be done by the provider of a downloadable App without having to get the cell phone service provider or phone maker involved, but it may require users to voluntarily use the App.

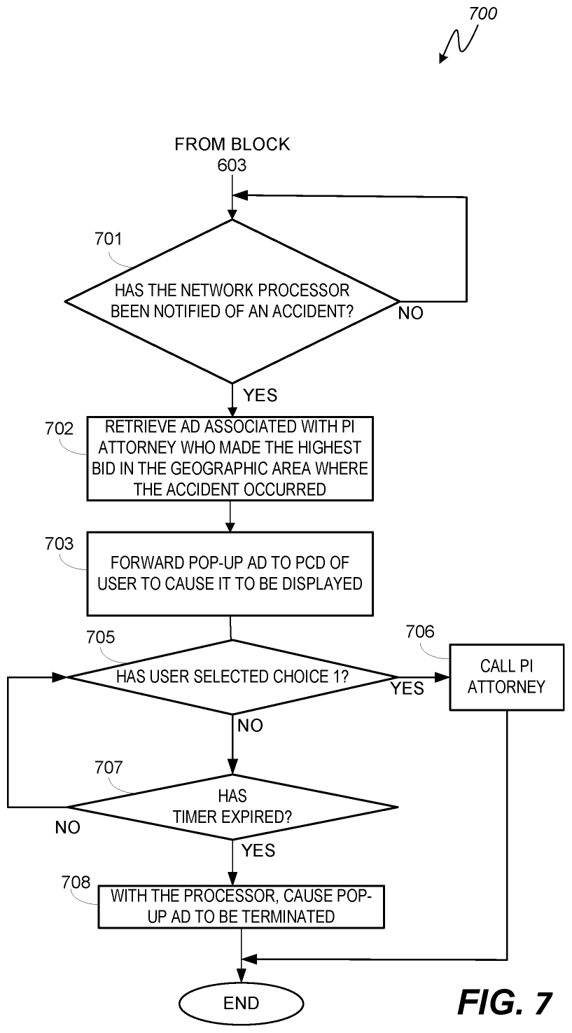

FIG. 7 is a flow diagram of the method in accordance with an exemplary embodiment in which the event detection algorithm 700 is the same as the event detection algorithm 600 shown in FIG. 6 except that the portion of the process after block 603 is performed by a processor of the network 103. In accordance with this representative embodiment, a network processor determines at block 701 which ad will be displayed and/or audibly presented on the PCD 20. For example, the provider of the network 103 can receive bids from PI attorneys in a geographic region and cause the ad for the PI attorney who made the highest bid to displayed and/or presented on the PCD 20 after the process represented by block 603 has been performed by the processor of the PCD 20. Therefore, these processors can be in communication with one another and cooperate with one another to perform the event detection algorithm 700. After the processor of the PCD 20 determines that an accident has likely occurred and notifies the network processor, the network processor, upon determining that it has been notified of an accident at block 701, determines at block 702 which PI attorney in the geographic area where the accident occurred made the highest bid and then forwards the ad to the PCD 20 to be displayed or presented on the PCD 20, as indicated by blocks 703. Blocks 705-708 can be identical blocks 605-608, respectively, of FIG. 6. The processes or steps represented by blocks 605-608 and by blocks 705-708 are optional.

It should be noted that the steps represented by blocks 701-708 can be performed by the processor 40 of the PCD 20 rather than by the network processor. For example, the memory device 50 of the PCD 20 can store a list of PI attorneys who made the highest bids for each geographical area in memory device 50. The list can be updated periodically by the network 103. In this case, block 701 could be eliminated and block 703 would be modified to remove the language about forwarding the ad to the PCD and would simply read “Cause Ad To Be Displayed on PCD.”

Some portions of this specification are presented in terms of algorithms performing operations on data stored as bits or binary digital signals within a machine memory (e.g., a computer memory). As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a system for purposes of illustration only. One skilled in the art will readily recognize from the description that alternative embodiments of the structures and methods illustrated herein may be employed without departing from the principles described herein.

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein.

Various modifications, changes and variations, which will be apparent to those skilled in the art, may be made in the arrangement, operation and details of the method and apparatus disclosed herein without departing from the spirit and scope defined in the appended claims.

It should be noted that any or all portions of algorithms described above that are implemented in software and/or firmware being executed by a processor (e.g., processor 40) can be stored in a non-transitory memory device, such as the memory 50. For any component discussed herein that is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages. The term “executable” means a program file that is in a form that can ultimately be run by the processor 40. Examples of executable programs may be, for example, a compiled program that can be translated into machine code in a format that can be loaded into a random access portion of the memory 50 and run by the processor 40, source code that may be expressed in proper format such as object code that is capable of being loaded into a random access portion of the memory 50 and executed by the processor 40, or source code that may be interpreted by another executable program to generate instructions in a random access portion of the memory 50 to be executed by the processor 40, etc. An executable program may be stored in any portion or component of the memory 50 including, for example, random access memory (RAM), read-only memory (ROM), hard drive, solid-state drive, USB flash drive, memory card, optical disc such as compact disc (CD) or digital versatile disc (DVD), floppy disk, magnetic tape, static random access memory (SRAM), dynamic random access memory (DRAM), magnetic random access memory (MRAM), a programmable read-only memory (PROM), an erasable programmable read-only memory (EPROM), an electrically erasable programmable read-only memory (EEPROM), or other like memory device.

It should be noted that the inventive principles and concepts have been described with reference to representative embodiments, but that the inventive principles and concepts are not limited to the representative embodiments described herein. As indicated above, steps not depicted in the flow diagrams can be added and steps that are depicted in the flow diagrams can be modified or eliminated altogether. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the Appended claims.

What is claimed is:

1. A system comprising:
a personal computing device (PCD) comprising:
at least a first sensor configured to sense conditions surrounding the PCD and to generate output signals indicative of the sensed conditions; and
an event detection system comprising a processor configured to perform an event detection algorithm that monitors and processes the output signals generated by said at least one sensor to detect if a high likelihood exists that a vehicle in which the PCD is traveling has been involved in an accident or collision, and if so, to cause at least one notification to be output on at least one output device of the PCD, wherein the notification conveys information to a user of the PCD about at least one assistance provider.

2. The system of claim 1, wherein said at least one notification comprises an audio notification output on an audio output device of the PCD.

3. The system of claim 1, wherein said at least one notification comprises a visual notification output on a visual display device of the PCD.

4. The system of claim 1, wherein the information includes one or more of a name of said at least one assistance provider, a phone number of said at least one assistance service provider, an email address of said at least one service provider, and a website of said at least one assistance provider.

5. The system of claim 4, wherein said at least one assistance provider is selected from a group comprising a person, a hospital, an emergency responder, a medical professional, a fire department, a personal injury attorney, and an insurance agent.

6. The system of claim 1, wherein the processor is further configured to cause a notification to be sent to said at least one assistance provider, the notification that the processor causes to be sent to said at least one assistance provider being at least one of a phone call, a short message service (SMS) message, a text message and an electronic mail (email) message.

7. The system of claim 6, wherein the notification that the processor causes to be sent to said at least one assistance provider includes at least one of a location where the accident or collision occurred, a time at which the accident or collision occurred, a name of a user of the PCD, a phone number associated with the user of the PCD, a residence address of the user of the PCD and email address of the user of the PCD.

8. The system of claim 1, wherein said at least a first sensor comprises at least one of a Global Positioning System (GPS) sensor, an accelerometer sensor, a magnetometer sensor, a gyroscope sensor, and a motion sensor.

9. The system of claim 1, wherein the notification is an advertisement advertising services of an attorney, and wherein the event detection algorithm presents one or more selection options to the user of the PCD to provide the user with at least one option, which, if selected by the user, causes the PCD to initiate a call to the attorney.

10. The system of claim 9, wherein at least one of said one or more selection options, if selected by the user, causes the advertisement to be terminated.

11. The system of claim 9, wherein if the processor performing the event detection algorithm detects that a high likelihood exists that a vehicle in which the PCD is traveling has been involved in an accident or collision, the processor notifies a processor of a network that an accident has occurred, and wherein upon being notified that an accident has occurred, the network processor selects an attorney from a list based on one or more predetermined factors, retrieves an advertisement associated with the selected attorney from a memory device and causes the retrieved advertisement to be forwarded to the processor of the PCD, and wherein the processor of the PCD causes the retrieved advertisement to be presented to the user on the PCD as the notification.

12. The system of claim 11, wherein if the processor performing the event detection algorithm detects that a high likelihood exists that a vehicle in which the PCD is traveling has been involved in an accident or collision, the processor notifies a processor of a network that an accident has occurred, and wherein upon being notified that an accident has occurred, the network processor selects an attorney from a list based on one or more predetermined factors, retrieves an advertisement associated with the selected attorney from a memory device and causes the retrieved advertisement to be forwarded to the processor of the PCD, and wherein the processor of the PCD causes the retrieved advertisement to be presented to the user on the PCD as the notification.

13. The system of claim 12, wherein said one or more predetermined factors include whether the selected attorney won a financial bid to advertise in a geographical region where the accident or collision occurred.

14. The system of claim 11, wherein if the processor performing the event detection algorithm detects that a high likelihood exists that a vehicle in which the PCD is traveling has been involved in an accident or collision, the processor selects an attorney from a list based on one or more predetermined factors, retrieves an advertisement associated with the selected attorney from a memory device and causes the retrieved advertisement to be presented to the user on the PCD as the notification.

15. The system of claim 14, wherein said one or more predetermined factors include whether the selected attorney won a financial bid to advertise in a geographical region where the accident or collision occurred.

16. A method comprising:
with at least a first sensor of a personal computing device (PCD), sensing conditions surrounding the PCD and generating output signals; and
with a processor of an event detection system of the PCD, performing an event detection algorithm that monitors and processes the output signals generated by said at least a first sensor to detect if a high likelihood exists that a vehicle in which the PCD is traveling has been involved in an accident or collision, and if so, causing at least one notification to be output on at least one output device of the PCD, wherein said at least one notification conveys information to a user of the PCD about at least one assistance provider.

17. The method of claim 16, wherein said at least one notification comprises an audio notification output on an audio output device of the PCD.

18. The method of claim 16, wherein said at least one notification comprises a visual notification output on a visual display device of the PCD.

19. The method of claim 16, wherein the information includes one or more of a name of said at least one assistance provider, a phone number of said at least one assistance service provider, an email address of said at least one service provider, and a website of said at least one assistance provider.

20. The method of claim 19, wherein said at least one assistance provider is selected from a group comprising a person, a hospital, an emergency responder, a medical professional, a fire department, a personal injury attorney, and an insurance agent.

21. The method of claim 16, further comprising:
with the processor performing the event detection algorithm, causing a notification to be sent to said at least one assistance provider, the notification that the processor causes to be sent to said at least one assistance provider being at least one of a phone call, a short message service (SMS) message, a text message and an electronic mail (email) message.

22. The method of claim 21, wherein the notification that the processor causes to be sent to said at least one assistance provider includes at least one of a location where the accident or collision occurred, a time at which the accident or collision occurred, a name of a user of the PCD, a phone number associated with the user of the PCD, a residence address of the user of the PCD and email address of the user of the PCD.

23. The method of claim 16, wherein said at least a first sensor comprises at least one of a Global Positioning System (GPS) sensor, an accelerometer sensor, a magnetometer sensor, a gyroscope sensor, and a motion sensor.

24. The method system of claim 16, wherein the notification is an advertisement advertising services of an attorney, and wherein the event detection algorithm presents one or more selection options to the user of the PCD to provide the user with at least one option, which, if selected by the user, causes the PCD to initiate a call to the attorney.

25. The method of claim 24, wherein at least one of said one or more selection options, if selected by the user, causes the advertisement to be terminated.

26. The method of claim 16, wherein if the processor performing the event detection algorithm detects that a high likelihood exists that a vehicle in which the PCD is traveling has been involved in an accident or collision, the processor notifies a processor of a network that an accident has occurred, and wherein upon being notified that an accident has occurred, the network processor selects an attorney from a list based on one or more predetermined factors, retrieves an advertisement associated with the selected attorney from a memory device and causes the retrieved advertisement to be forwarded to the processor of the PCD, and wherein the processor of the PCD causes the retrieved advertisement to be presented to the user on the PCD as the notification.

27. The method of claim 26, wherein said one or more predetermined factors include whether the selected attorney won a financial bid to advertise in a geographical region where the accident or collision occurred.

28. The method of claim 16, wherein if the processor performing the event detection algorithm detects that a high likelihood exists that a vehicle in which the PCD is traveling has been involved in an accident or collision, the processor selects an attorney from a list based on one or more predetermined factors, retrieves an advertisement associated with the selected attorney from a memory device and causes the retrieved advertisement to be presented to the user on the PCD as the notification.

29. The method of claim 28, wherein said one or more predetermined factors include whether the selected attorney won a financial bid to advertise in a geographical region where the accident or collision occurred.

30. A computer program comprising instructions for execution by a processor for performing an event detection algorithm, the computer program being embodied on a nontransitory computer-readable medium, the computer program comprising:
a first code segment that receives output signals generated by at least a first sensor of a personal computing device (PCD), the output signals corresponding to conditions surrounding the PCD that are sensed by said one or more sensors; and
a second code comprising an event detection algorithm that monitors and processes the output signals generated by said at least a first sensor to determine if a high likelihood exists that a vehicle in which the PCD is traveling has been involved in an accident or collision, and if so, causing at least one notification to be output on at least one output device of the PCD, said at least one notification conveying information to a user of the PCD about at least one assistance provider.

31. The computer program of claim 30, wherein said at least one notification comprises at least one of an audio notification output on an audio output device of the PCD and a visual notification output on a visual display device of the PCD.

32. The computer program of claim 30, wherein the information includes one or more of a name of said at least one assistance provider, a phone number of said at least one assistance service provider, an email address of said at least one service provider, and a website of said at least one assistance provider, and wherein said at least one assistance provider is selected from a group comprising a person, a hospital, an emergency responder, a medical professional, a fire department, a personal injury attorney, and an insurance agent.

33. The computer program of claim 30, further comprising:
a third code segment that causes a notification to be sent to said at least one assistance provider, the notification that the processor causes to be sent to said at least one assistance provider being at least one of a phone call, a short message service (SMS) message, a text message and an electronic mail (email) message, and wherein the notification that the third code segment causes to be sent to said at least one assistance provider includes at least one of a location where the accident or collision occurred, a time at which the accident or collision occurred, a name of a user of the PCD, a phone number associated with the user of the PCD, a residence address of the user of the PCD and email address of the user of the PCD.
